(19) United States
(12) Patent Application Publication
(10) Pub. No.: US 2011/0164605 A1
(43) Pub. Date: Jul. 7, 2011

(54) WIRELESS COMMUNICATION SYSTEM

(75) Inventors: Bin Zhen, Tokyo (JP); Huan-Bang Li, Tokyo (JP); Ryuji Kohno, Tokyo (JP)

(73) Assignee: NATIONAL INSTITUTE OF INFORMATION AND COMMUNICATIONS TECHNOLOGY, Koganei-shi, Tokyo (JP)

(21) Appl. No.: 13/062,776

(22) PCT Filed: Sep. 9, 2008
(86) PCT No.: PCT/JP2008/002488

§ 371 Date: Mar. 8, 2011

(51) Int. Cl. H04B 7/212; H04J 3/06

(52) U.S. Cl. 370/347; 370/345

(57) ABSTRACT

A wireless communication system includes a coordinator (3) that broadcasts a beacon (21) having at least a preamble part (32) and a payload part (33), and a plurality of devices (2) each of which is synchronizable with at least the coordinator (3) by listening to the beacon (21) through a listen period set based on an own reference clock. The coordinator (3) fixes a position of the end of the beacon (21) with respect to a beacon slot constituting a superframe, and generates the beacon (21) where a start of a preamble part (32) is extended toward a start of the beacon slot over a time To. The devices (2) are synchronized with the coordinator (3) via an end time of the beacon slot detected from an end time of the preamble part (32) in the beacon frame.

### TECHNICAL FIELD

The present invention relates to a wireless communication system which enables wireless communication between a plurality of devices attached to a human body or implanted therein and a coordinator.

### BACKGROUND ART

In diagnosing a human body, the blood pressure and cardiogram are particularly important parameters in discriminating the current health state of a patient. There also is a case where an athlete wants to measure his/her physical conditions during sports to improve the skill or the quality of training.

In this respect, there is proposed a cable communication system in which devices are attached to a human body to transmit various kinds of information measured by the devices to a wired monitor, and the information is grasped through monitor images. However, the cables are easily tangled, and there is a restriction on the distance from a patient to the monitor due to the lengths of the cables. An additional problem is that the presence of the cables becomes a barrier when actually performing sports.

Therefore, there are increasing cases in the recent medical and sports applications where devices are implanted in or attached to a human body to treat or diagnose the human body. Accordingly, attention is paid to researches on systems which establish wireless communication links between devices implanted in or attached to a human body and a base station to carry out wireless communication. Construction of the system among those devices which is focused on the high speed of communication, usability and reliability to acquire test data of a patient or body data of an athlete in real time is underway.

However, those devices require a certain power on which at least a CPU (Central Processing Unit) operates and have their battery capacities or the like determined so that as the devices are attached to a human body, they should be always operable even in an unstable state.

In case that the internal physical data transmitted via the devices needs to be monitored continuously, the batteries of the devices are consumed soon. Especially, it is neither economical nor practical to replace the battery of a device frequently once implanted in a human body. Therefore, devices which are attached to or implanted in a human body need to be particularly designed for low consumption power.
Non-patent Literature 1: “Standard for Part 15.4 (2006): Wireless Medium Access Control (MAC) and Physical Layer (PHY) Specifications for Low Rate Wireless Personal Area Networks”, ANSI/IEEE 802.15.4, 2006.
Non-patent Literature 2: A. EI-Hoiydi, “Aloha with preamble sampling for sporadic traffic in ad hoc wireless sensor networks,” IEEE Conference ICC'02, vol. 5, p. 3418-3423, 2005.
Non-patent Literature 3: M. Buettner, G. V. Yee, E. Anderson and R. Han, “X-MAC: a short preamble MAC protocol for duty-cycled wireless sensor networks”, ACM Conference SenSys'05, p. 307-320, 2006.
Non-patent Literature 4: W. Ye, J. Heidemann and D. Estrin, “Medium access control with coordinated, adaptive sleeping for wireless sensor networks”, ACM/IEEE Transactions on Networking, vol. 12, no. 3, p. 493-506, 2004.

### DISCLOSURE OF THE INVENTION

### Problems to be Solved by the Invention

Especially, standardization of such wireless PAN (Wireless Personal Area Network) is undergoing in the IEEE (Institute of Electrical and Electronics Engineering). In a wireless communication system typified by wireless PAN, contention of radio resources between a plurality of terminals is regarded as a problem. In order to avoid contention of radio resources, media access control (MAC) is needed. Proposed as a MAC protocol in this wireless PAN, is the CSMA (Carrier Sense Multiple Access). In which a terminal conducts a so-called carrier sensing, i.e., detection of the subcarriers of other terminals before it transmits a packet. But a carrier cannot be captured in some systems. Further, the CSMA/CA (Carrier Sense Multiple Access with Collision Avoidance) system which has the function of the collision avoidance in addition to the CSMA system is proposed.

In this CSMA/CA system, when communication is started and the reply of an ACK (Acknowledge) signal is received from the wireless node of a communications partner, it is regarded that communication has succeeded, and when an ACK signal is not received, it is regarded that communication collision with other wireless nodes has occurred, and a back-off time is added before resending packet data.

In recent years, a lot of standards including IEEE802.11 and IEEE802.15.4 employ CSMA/CA based system. Each standard specifies PHY and/or MAC layers and uses common defined network layer as well as application layer. Especially, by taking use the advantage of CSMA/CA system, IEEE802.15.4 enables extremely low power consumption, miniaturization, as well as reduction of cost. Systems based on such standards are suitable for the aforementioned various medical systems attached to a human body.

In the wireless communication based on those standards, a so-called superframe structure that uses a beacon is adopted. This superframe structure is divided into a CAP (Contention Access Period) where all devices can access the beacon interval, a CFP (Contention Free Period) where a specific device can monopolize the access, etc. The CFP is equally divided into seven slots by a GTS (Guaranty Time Slot) mechanism, and can be allocated to a device which wants to communicate with priority.

In the case where devices listen to a beacon, the listening is carried out in a listen period set for each device based on its own reference clock. However, the reference clock may differ between the devices, so that the listen period differs as shown in FIG. 7.

FIG. 7 shows the listen periods of three devices A to C that try to listen to a beacon frame 60 which has a preamble part 61 and a payload part 62. The devices A to C have different reference clocks, so that the listen periods differ from one another. The beacon frame is transmitted from a coordinator to the individual devices A to C at the same timing, but may not be necessarily captured by every device because the listen periods of the devices A to C differ from one another. For example, the devices A and B can listen to the beacon frame entirely from the start to the end, whereas the device C cannot listen to at least the start of the beacon frame and cannot discriminate where the beacon frame starts from. As a result, this wireless communication system cannot establish synchronization between the coordinator and all the devices A to C.

To permit the coordinator to establish synchronization with all the devices, the listen periods of the devices are processed to be uniformly extended on the premise that there always is a difference between the listen periods of the devices A to C due to the difference between the reference clocks (see, for example, Non-patent Literature 1).

Extension of the listen periods of the individual devices A to C can surely increase the possibility that every device can catch a beacon frame from the start to the end, but the longer the listen period becomes, the greater the power consumption is. Since the devices are attached to or implanted in a human body, frequent replacement of the battery should be avoided as much as possible. This makes it necessary to suppress power consumption of the devices as much as possible.

Non-patent Literatures 2 to 4 propose various kinds of applications aiming at suppressing power consumption, but have not essentially overcome the aforementioned problems.

Accordingly, the present invention has been made in view of the problems, and it is an object of the invention to provide a wireless communication system and method which can reliably establish synchronization by allowing every device to catch a beacon frame while suppressing power consumption by shortening the listen periods of the devices.

### Means for Solving the Problems

To overcome the problems, a wireless communication system according to the invention includes a coordinator that broadcasts a beacon frame having at least a preamble part and a payload part, and a plurality of devices each of which is synchronizable with at least the coordinator by listening to the beacon frame through a listen period set based on its own reference clock, the coordinator fixing a position of the preamble part in the beacon frame with respect to a beacon slot constituting a superframe, and generating the beacon frame where a start of the preamble part is extended toward a start of the beacon slot over a time To, the devices being synchronized with the coordinator via information detected from an end time of the preamble part in the beacon frame.

To solve the problems, a wireless communication method according to the invention includes broadcasting a beacon frame having at least a preamble part and a payload part from a coordinator; permitting a device to listen to the beacon frame through a listen period set based on its own reference clock, thereby enabling synchronization with the coordinator; causing the coordinator to fix a position of the preamble part in the beacon frame with respect to a beacon slot constituting a superframe, and generate the superframe where a start of the preamble part is extended toward a start of the beacon slot over a time To; and causing the devices to be synchronized with the coordinator via information detected from an end time of the preamble part in the beacon frame.

### Effect of the Invention

The invention with the above configuration can reliably establish synchronization by allowing every device to catch a beacon frame while suppressing power consumption by shortening the listen periods of the devices.

### BEST MODE OF CARRYING OUT THE INVENTION

A wireless communication system which is adapted to the wireless personal area environment will be explained as the best mode of carrying out the invention by referring to the accompanying drawings.

A wireless communication system 1 to which the invention is adapted, for example, includes a plurality of devices 2, and a coordinator 3 which controls the entire network as shown in FIG. 1. The wireless communication system 1 is not limited to a star type as shown in FIG. 1, and may adopt any network configuration, such as a tree type or a mesh type.

In the wireless communication system 1, the devices 2 may be, for example, implanted in a human body 5 or attached to the human body 5. The coordinator 3 may be disposed outside the human body 5. In this case, the devices 2 take pictures of the interior of the human body 5 or sense various kinds of information in the human body, and transmit the acquired data to the coordinator 3 outside the human body. The coordinator 3 receives the data, displays the data on a monitor 6 when needed, and analyzes the data to detect an abnormality of the human body. The coordinator 3 is connected to a public communication network 7 with a cable or wirelessly.

The wireless communication system 1 is premised that the coordinator 3 communicates with the devices 2 based on a time division multiple access (TDMA) protocol.

The devices 2 are assumed to be all sorts of electronic devices including at least a CPU (Central Processing Unit). Especially, the device 2 may be made by a microminiature chip including a CPU as long as it is premised that the device is implanted in or attached to the human body 5 in application. When the device 2 is used in other purposes than acquisition of various kinds of internal physical data from the device 2, for example, attached to the human body, the device may be constructed by various kinds of portable information terminals, such as a notebook type personal computer (notebook PC) and a cellular phone. The device 2 can carry out wireless communication at least with the coordinator 3, and further can carry out wireless packet communication with other devices 2 via the coordinator 3.

The coordinator 3 includes a terminal device or a portable information terminal which operates under control of the CPU. The coordinator 3 allocates data transmitted from the devices 2 to data slots managed by the coordinator. In addition, the coordinator 3 manages a plurality of devices 2 based on index information, numbers, etc.

As shown in FIG. 2, for example, the wireless communication system 1 to which the invention is adapted uses a so-called superframe structure that uses a beacon 21. The minimum cycle of the superframe is 15.36 ms, and a CAP (Contention Access Period) 22 and CFP (Contention Free Period) 23 follow the beacon 21. This frame structure needs to secure a section of a minimum of 240 bytes with respect to the CAP (Contention Access Period) 22 called a contention communication period. Further, the time between two beacons 21 is divided into a predetermined number of slots regardless of the cycle of the superframe. An unillustrated Inactive period or the like where access to every device 2 is inhibited may be inserted after the CFP 23 as needed.

The beacon 21 is frame data to be inserted in a beacon slot 31. Each of the CAP 22 and CFP 23 is divided into a data frame 41 and an Ack frame 42 in which actual data is inserted.

Based on the superframe structure, a superframe group 27 which includes a plurality of superframes 26, can be formed. A superframe in which the beacon 21 is inserted is set active, and a superframe in which the beacon 21 is not inserted is set in sleep mode. That is, in this superframe structure, when the amount of accesses and the access frequency of multiple devices 2 increase which needs allocation of a vast amount of data to slots, the beacon 21 is inserted in many of the superframes 26 forming a superframe group 27 to set the superframes active, so that data can be allocated to those superframes. When the amount of accesses and the access frequency of multiple devices 2 are small so that it is unnecessary to allocate a vast amount of data to slots, the beacon 21 is inserted in a minimum number of superframes 26 necessary in the frame group 27 to set the superframes active, and the beacon 21 is not inserted in the remaining superframes to set them in sleep mode. That is, the consumption power of the coordinator 3 can be reduced by increasing the quantity of the superframes 26 which are in sleep mode.

In the wireless communication system 1 to which the invention is adapted, as apparent from the above, when there is a small amount of data to be transmitted, the quantity of the superframes 26 which are in sleep mode can be increased, thus saving the power, and when the amount of data transmission is large, the quantity of active superframes 26 is increased to cope with this case.

Index information may be added to each superframe 26 forming the superframe group. In this case, the coordinator 3 may control the individual superframe 26 through the index information or may perform various kinds of control including insertion or non-insertion of the beacon 21 through the index information.

Next, a description will be given of the relationship between the beacon 21 generated from the coordinator 3 in the wireless communication system 1 to which the invention is adapted, and the listen period of the device 2 which actually attempts to listen (catch) the beacon 21.

FIG. 3 shows the enlarged structure of the beacon slot 31. The frame structure of the beacon 21 has a preamble part 32 and a payload part 33 where actual data is written. A frame delimiter 34 is inserted between the preamble part 32 and the payload part 33.

Actually, for synchronization of the device 2 with the coordinator 3, it is necessary to identify the start time or the end time of the beacon slot 31. Conventionally, to identify the start time of the beacon slot 31, the start of the beacon 21 is aligned with the start of the beacon slot 31 as shown in FIG. 3A. Hereinafter, this method is called B-B method. According to the B-B method, for the device 2 to surely listen to the start of the beacon 21, the start of a listen period t11 is set before the start of the beacon slot 31. Since the listen period is likely to differ from one device 2 to another as mentioned above, to surely listen from the start of the beacon 21, beginning of the listening is started earlier to extend the listen period t11. However, the B-B method cannot avoid an increase in the consumption power of the device 2 originated from the aforementioned extension of the listen period of the device 2.

According to the invention, therefore, the start of the beacon 21 is not aligned with the start of the beacon slot 31, but the end of the beacon 21 is fixed with respect to the beacon slot 31 as shown in FIG. 3B. The fixed position of the end of the beacon 21 may be optional or may be aligned with the end of the beacon slot 31. That is, it may be such that the position of the preamble part 32 in the beacon 21 is fixed with respect to the beacon slot 31 constituting the superframe 26. Hereinafter, this method is called B-E method. In addition, the start of the preamble part 32 in the beacon 21 is extended toward the start of the beacon slot 31 over a time To. A listen period t12 of the device 2 is not particularly extended and is set short. As a result, the structure has the preamble part 32 extended as shown in FIG. 3B.

According to the B-E method, the device 2 detects the end time of the preamble part 32 in the beacon 21. As a result, the device 2 can acquire information on the reference clock set by the coordinator 3. The start time of the frame delimiter 34 which, in other words, is the end time of the preamble part 32 may be acquired.

The device 2 is synchronized with the coordinator 3 via information on the end time of the preamble part 32. This is because if the device 2 can know the end time of the preamble part 32 (start time of the frame delimiter 34), the device 2 can be synchronized with the coordinator 3 by using information on the frame length or the like described in the payload part 33. According to the invention, particularly, it is premised that communication is carried out based on the time division multiple access (TDMA) protocol, so that when the position of the beacon slot 31 is accurately grasped, each device 2 can accurately use the data slot allocated to itself. Therefore, it can be said that the invention particularly demonstrates an advantageous effect at the time of adopting the TDMA.

To achieve the synchronization of the device 2 with the coordinator 3, the end of the preamble part 32 should overlap the listen period t12, which allows the end time of the preamble part 32 to be read.

What is more, since the start of the preamble part 32 is extended toward the start of the beacon slot 31 over the time To, the listen period t12, if shortened, can be made to overlap the end of the preamble part 32 in terms of time with high probability, thus making it possible to read the end time of the preamble part 32. It is therefore possible to set the listen period t12 of every device 2 shorter, so that the consumption power of the device 2 itself can be reduced. As a result, the wireless communication system 1 to which the invention is adapted can eliminate the need for frequent replacement of the battery of the device 2 even if the device 2 is of a type which is attached to or implanted in a human body.

According to the invention, the time To may be decided based on the following equation (1).

To=min(2θTi,Ts·Td) (1)

wherein

θ: the accuracy of the clock of the coordinator 3 and each of the devices 2,

Ti: the time interval between neighboring superframe 26 listened by the device 2,

Ts: the period of the beacon slot 31, and

Td: the maximum period of the payload part 33 and the frame delimiter 34 in the frame of the beacon 21.

That is, in the equation 1, a smaller one of 2θTi and Ts·Td is set as To. 2θTi means that since Ti is a non-synchronized period and θ is the accuracy of the clock, θTi represents a time deviation. Since it is necessary to increase the accuracies of the clocks of both the device 2 and the coordinator 3, multiplication by 2 is intentionally taken. Ts·Td represents the time obtained by subtracting the maximum periods of the payload 33 and the frame delimiter 34 from the period Ts of the beacon slot 31, and is equivalent to the period from the start of the beacon slot 31 to the end of the preamble part 32. Since the extended start of the preamble part 32 exceeds the start of the beacon slot 31 when To to be set exceeds Ts·Td, Ts·d is defined as the maximum value of To.

The time To to be set is not limited to the case where it is set based on the equation 1, and it should be extended in such a way that the necessary preamble part 32 and payload part 33 can be captured over the listen periods respectively set based on the reference clock of each device 2.

Next, the operation of the wireless communication system 1 to which the invention is adapted will be described. FIG. 4 is a flowchart illustrating the procedures of transmitting data to the coordinator 3 from the device 2. First, in step S11, the coordinator 3 broadcasts a beacon 21 at the aforementioned timing. The device 2 listens to at least the end time of the preamble part 32 of the beacon 21 over the listen period, and then establishes synchronization with the coordinator 3 based on the acquired end time in step S12.

Next, in step S13, the device 2 transmits data to the coordinator 3. The coordinator 3 allocates and inserts the data transmitted from the device 2 to/into the CAP 22 or the CFP 23. Next, in step S14, the coordinator 3 transmits Ack to the device 2. This Ack includes information on the data slot of the CAP 22 or the CFP 23 to which the data is actually allocated. Consequently, the device 2 which has received the Ack can identify to which data slot in the CAP 22 or CFP 23 the data transmitted itself is allocated.

FIG. 5 is a flowchart illustrating the procedures of transmitting data to the device 2 from the coordinator 3. First, in step S21, the coordinator 3 broadcasts a beacon 21 at the aforementioned timing. The device 2 listens to at least the end time of the preamble part 32 of the beacon 21 over the listen period, and then establishes synchronization with the coordinator 3 based on the acquired end time in step S22.

Next, in step S23, the device 2 transmits a data transmission request to the coordinator 3. In step S24, the coordinator 3 allocates a data slot in the CFP 23 for data which will be transmitted from the device 2 from now on. Next, in step S25, the coordinator 3 transmits an Ack signal through the data slot in the CAP 22 to the device 2 which has transmitted the data transmission request. At this time, the coordinator 3 also notifies the device 2 of the data slot in the CFP 23 which has been allocated in step S24 is included in the Ack signal by including the data slot in the Ack signal. Consequently, the device 2 which has received the Ack can identify which data slot in the CFP 23 is allocated for the data which will be transmitted from the coordinator 3 from now on.

Next, in step S26, the coordinator 3 transmits data to the device 2. Since the device 2 previously knows the data slot of the CFP 23 allocated for the data to be transmitted through the Ack signal from the coordinator 3, the data is transmitted from the current slot, thus shortening the transmission start time. Further, since there is an effect such that the data is transmitted via the CFP 23, collision of data can be prevented.

Finally, in step S27, the device 2 transmits an Ack signal to the coordinator 3. This Ack signal informs the coordinator 3 of the completion of data reception.

FIG. 6 shows the relationship between the normalized consumption power of the device 2 during listening to the beacon 21 and the sleep time of the device 2. According to the B-B method, the normalized consumption power increases as the sleep time increases, whereas according to the B-E method to which the invention is adapted, the normalized consumption power hardly changes with an increase in sleep time. It is to be noted that the sleep function is a function added to the device 2, and the sleep time represents the time during which the device 2 is actually asleep.

### First Embodiment

An embodiment of the wireless communication system 1 to which the invention is adapted will be described below.

Table 1 shows an example of various parameters in the wireless communication system 1.

TABLE 1

| Parameter name | Values | | Description |
|---|---|---|---|
| Data rate | 1 | Mbps | Data rate of the physical channel |
| Turn-around | 32 | μs | Constant time for node to switch between |
| time | | | transmit and receive state |
| Ts | 2 | ms | Constant duration of a time slot |
| Td | 1 | ms | Constant position of frame delimiter in |
| | | | beacon relative to the end of slot boundary |

| | | |
|---|---|---|
| G | 1-16 | Number of superframes in a superframe |
| | | group |
| CA | 5-16 | Number of slots in the CAP |
| CF | 1-10 | Number of slots in the CFP |

Table 2 shows an example of the structure of the beacon frame.

TABLE 2

| Section name | Bits | Description |
|---|---|---|
| Preamble sequence | 32~1384 | Unique synchronization code, variable duration per Eq. 1 |
| Frame delimiter | 8 | Delimiter to indicate the start of beacon frame |
| Frame length | 8 | Total length of beacon frame in bytes |
| MAC layer header | 56 | MAC header of beacon |
| Time stamp | 8 | Sequence of the superframe in the superframe group |
| Superframe specification | 16 | Superframe formation |
| CFP allocation | 192 | Slot allocation in CFP |
| Pending address field | 80 | Maximal pending traffic to 10 nodes |
| Beacon payload | 40 | Beacon payload from management entity |
| Frame check sequence | 16 | Error check sequence of frame |

Table 3 shows an example of the structure of the data frame.

TABLE 3

| Section name | Bits | Description |
|---|---|---|
| Preamble sequence | 32 | Unique synchronization code |
| Frame delimiter | 8 | Delimiter to indicate the start of data |
| | | frame |
| Frame length | 8 | Total length of data frame in bytes |
| MAC layer header | 56 | MAC header of data |
| Data payload | 8~1024 | Data payload from high layer |
| Frame check sequence | 16 | Error check sequence of frame |

Table 4 shows an example of the structure of the Ack frame.

TABLE 4

| Section name | Bits | Description |
|---|---|---|
| Preamble sequence | 32 | Unique synchronization code |
| Frame delimiter | 8 | Delimiter to indicate the start of ACK |
| | | frame |
| Frame length | 8 | Total length of ACK frame in bytes |
| MAC layer header | 56 | MAC header of ACK |
| CFP slot | 8 | New slot allocation for failed uplink |
| | | communication or downlink communication |
| Frame check | 16 | Error check sequence of frame |
| sequence | | |

Table 5 shows an example of the structure of the MAC command frame.

TABLE 5

| Section name | Bits | Description |
|---|---|---|
| Preamble sequence | 32 | Unique synchronization code |
| Frame delimiter | 8 | Delimiter to indicate the |
| | | start of MAC frame |
| Frame length | 8 | Total length of beacon |
| | | frame in bytes |
| MAC layer header | 56 | MAC header of MAC frame |
| Command type | 8 | MAC command type from |
| | | management entity |
| Command payload | 8~1016 | MAC command payload from |
| | | management entity |
| Frame check | 16 | Error check sequence |
| sequence | | of frame |

### BRIEF DESCRIPTION OF THE DRAWINGS

FIG. 1 A diagram showing an example of the configuration of a wireless communication system to which the invention is adapted.

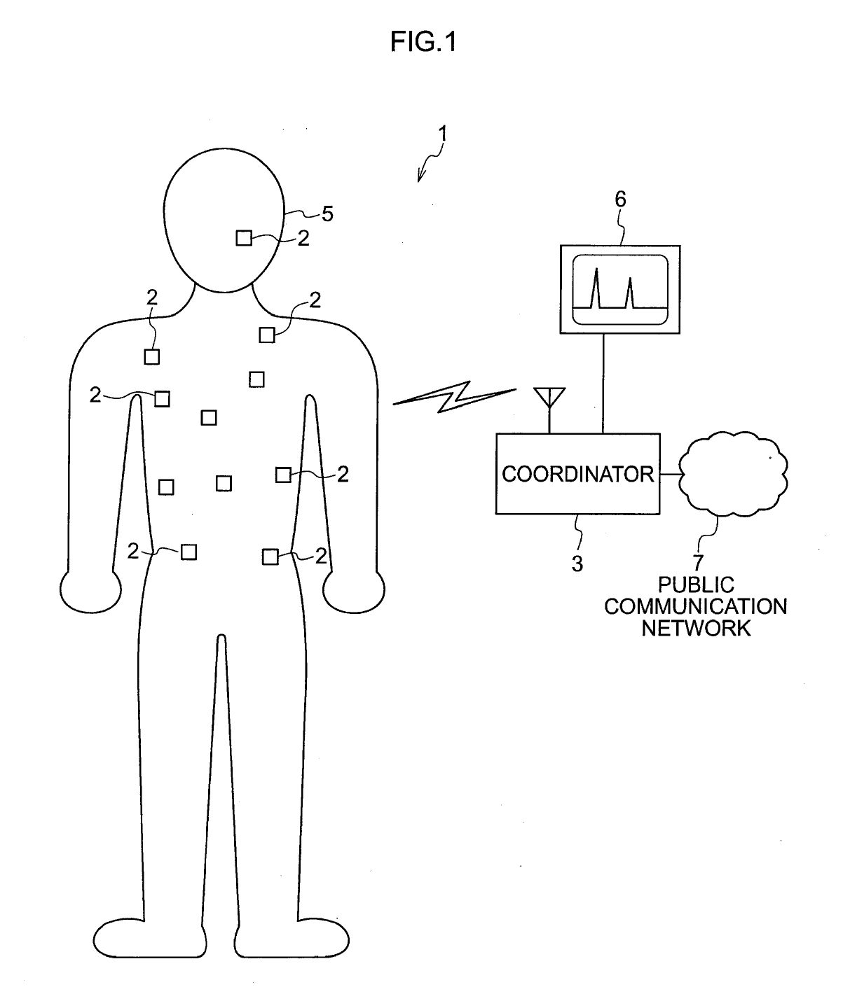

FIG. 2 A diagram for describing a superframe structure.

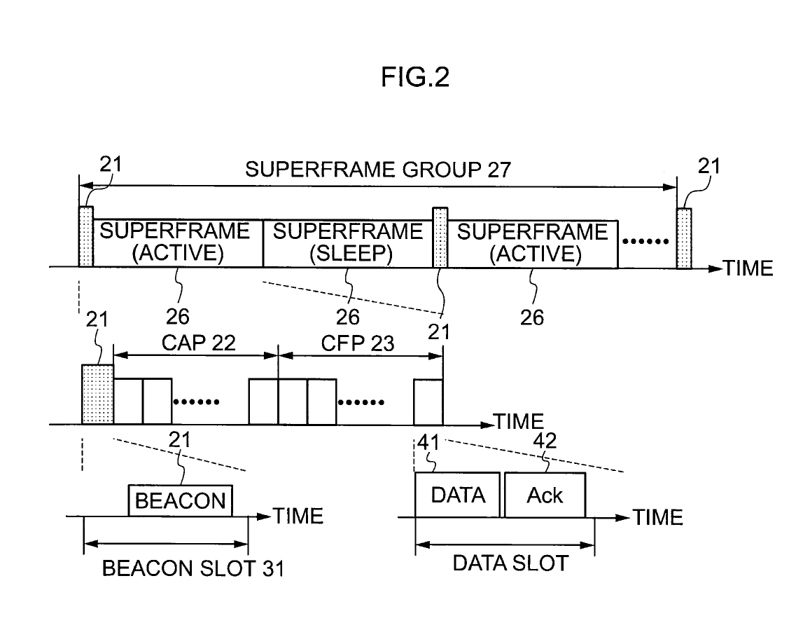

FIG. 3 A diagram showing an example of the structure of a beacon slot in enlargement.

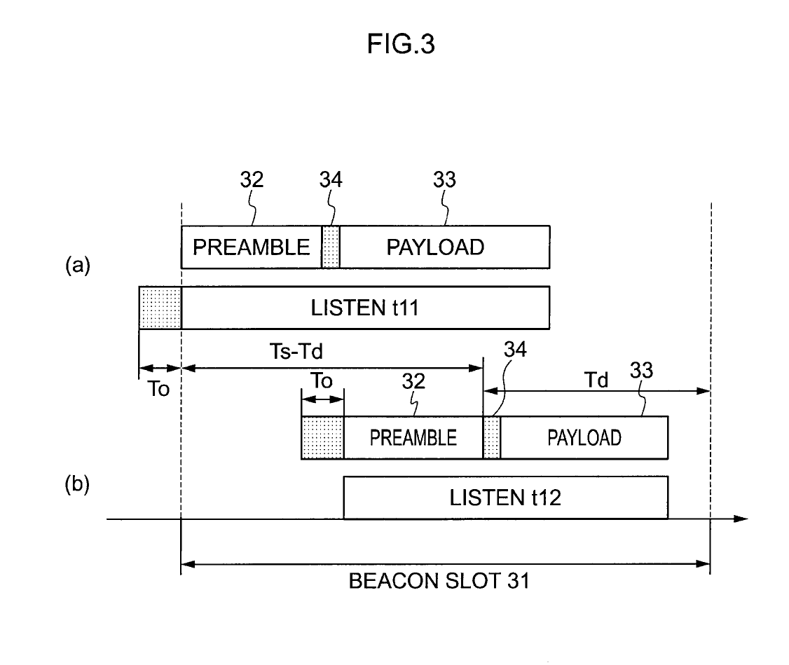

FIG. 4 A flowchart illustrating the procedures of transmitting data to a coordinator from a device.

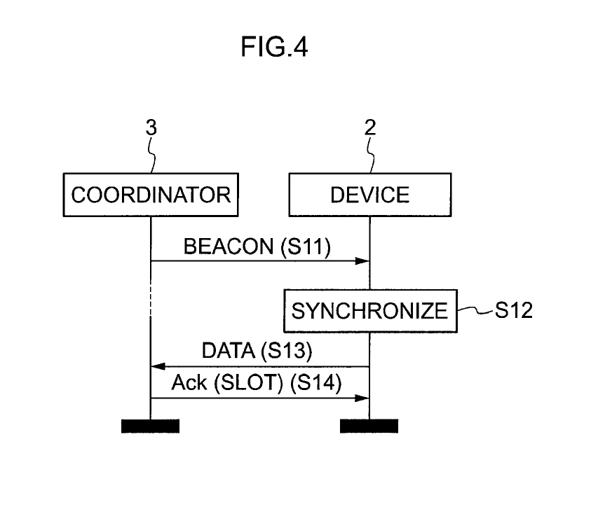

FIG. 5 A flowchart illustrating the procedures of transmitting data to the device from the coordinator.

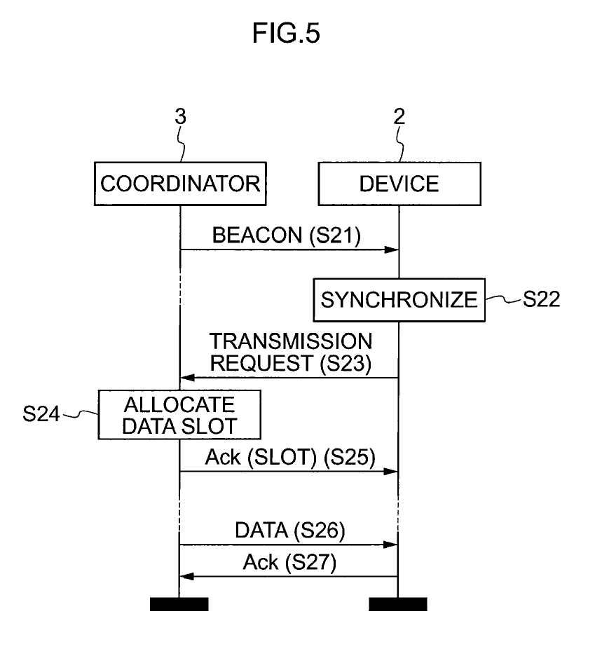

FIG. 6 A diagram for describing the effect of the wireless communication system to which the invention is adapted.

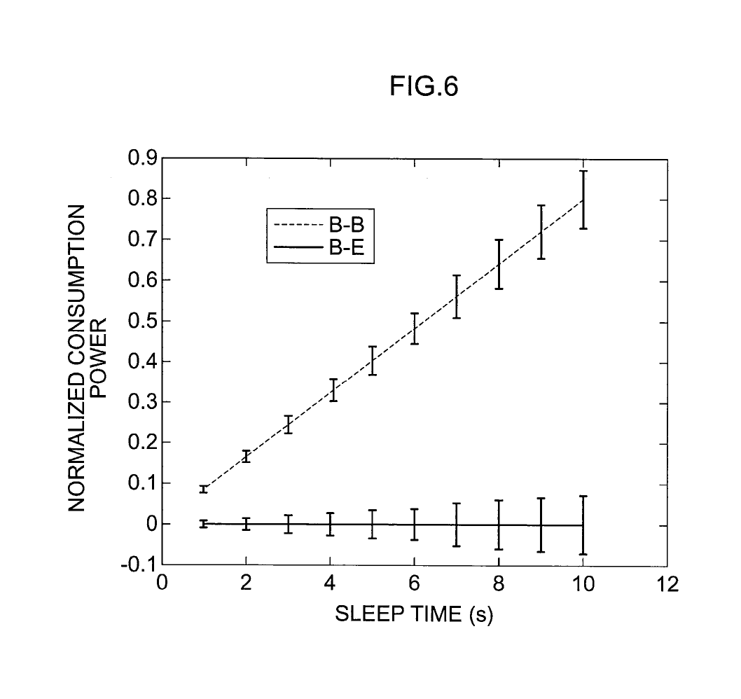

FIG. 7 A diagram for describing the problems of the related art.

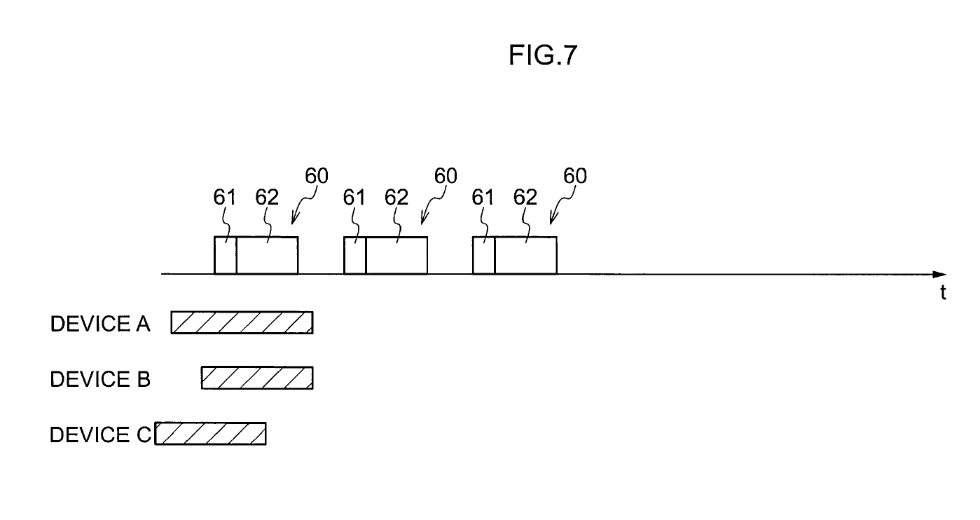

### DESCRIPTION OF REFERENCE NUMERALS

1 Wireless communication system
2 Device
3 Coordinator
5 Human body
6 Monitor
7 Public communication network
21 Beacon
22 CAP
23 CFP
26 Superframe
27 Superframe group
31 Beacon slot
32 Preamble part
33 Payload part
34 Frame delimiter
41 Data frame
42 Ack frame

1. A wireless communication system comprising: a coordinator that broadcasts a beacon frame having at least a preamble part and a payload part; and
a plurality of devices each of which is synchronizable with at least the coordinator by listening to the beacon frame through a listen period set based on an own reference clock,
the coordinator fixing a position of the preamble part in the beacon frame with respect to a beacon slot constituting a superframe, and generating the beacon frame where a start of the preamble part is extended toward a start of the beacon slot over a time To,
the devices being synchronized with the coordinator via information detected from an end time of the preamble part in the beacon frame.

2. The wireless communication system according to claim 1, wherein the coordinator extends the time To so as to be able to catch a preamble part and payload part necessary through the listen period set based on the reference clock of each device.

3. The wireless communication system according to claim 1, wherein the coordinator determines the time To based on the following equation (1)
To=min(2θTi,Ts·Td) (1)
where
θ: accuracy of a clock of the coordinator and each of the devices,
Ti: a time interval between neighboring superframes listened to by the device,
Ts: a period of the beacon slot, and
Td: a maximum period of the payload part and a frame delimiter in the beacon frame.

4. The wireless communication system according to claim 1, wherein the coordinator forms a superframe group having a plurality of superframes arranged therein, makes a superframe having the beacon frame inserted therein active, and makes a superframe in which the beacon frame is not inserted in sleep mode.

5. The wireless communication system according to claim 1, wherein index information is added to the superframes constituting the superframe group, and the coordinator controls each of the superframes via the index information.

6. The wireless communication system according to claim 1, wherein the coordinator and the devices communicate based on a time division multiple access (TDMA) protocol.

7. The wireless communication system according to claim 1, wherein upon reception of a request for data transmission from a synchronized device, the coordinator transmits an Ack signal to the device via a data slot in a CAP (Contention Access Period) following the beacon frame, and notifies the device of a slot in a CFP (Contention Free Period) which is allocated for data to be transmitted to the device by including the slot in the Ack signal.

8. A wireless communication method comprising: broadcasting a beacon frame having at least a preamble part and a payload part from a coordinator; and
permitting a device to listen to the beacon frame through a listen period set based on an own reference clock, thereby enabling synchronization with the coordinator;
wherein the coordinator fixes a position of the preamble part in the beacon frame with respect to a beacon slot constituting a superframe, and generates the beacon frame where a start of the preamble part is extended toward a start of the beacon slot over a time To; and
the devices is synchronized with the coordinator via information detected from an end time of the preamble part in the beacon frame.

9. The wireless communication system according to claim 2, wherein the coordinator determines the time To based on the following equation (1)
To=min(2θTi,Ts·Td) (1)
where
θ: accuracy of a clock of the coordinator and each of the devices,
Ti: a time interval between neighboring superframes listened to by the device,
Ts: a period of the beacon slot, and
Td: a maximum period of the payload part and a frame delimiter in the beacon frame.

10. The wireless communication system according to claim 9, wherein the coordinator forms a superframe group having a plurality of superframes arranged therein, makes a superframe having the beacon frame inserted therein active, and makes a superframe in which the beacon frame is not inserted in sleep mode.

11. The wireless communication system according to claim 2, wherein the coordinator forms a superframe group having a plurality of superframes arranged therein, makes a superframe having the beacon frame inserted therein active, and makes a superframe in which the beacon frame is not inserted in sleep mode.

12. The wireless communication system according to claim 3, wherein the coordinator forms a superframe group having a plurality of superframes arranged therein, makes a superframe having the beacon frame inserted therein active, and makes a superframe in which the beacon frame is not inserted in sleep mode.

13. The wireless communication system according to claim 10, wherein index information is added to the superframes constituting the superframe group, and the coordinator controls each of the superframes via the index information.

14. The wireless communication system according claim 11, wherein index information is added to the superframes constituting the superframe group, and the coordinator controls each of the superframes via the index information.

15. The wireless communication system according to claim 12, wherein index information is added to the superframes constituting the superframe group, and the coordinator controls each of the superframes via the index information.

16. The wireless communication system according to claim 9, wherein the coordinator and the devices communicate based on a time division multiple access (TDMA) protocol.

17. The wireless communication system according to claim 2, wherein the coordinator and the devices communicate based on a time division multiple access (TDMA) protocol.

18. The wireless communication system according to claim 3, wherein the coordinator and the devices communicate based on a time division multiple access (TDMA) protocol.

19. The wireless communication system according to claim 2, wherein upon reception of a request for data transmission from a synchronized device, the coordinator transmits an Ack signal to the device via a data slot in a CAP (Contention Access Period) following the beacon frame, and notifies the device of a slot in a CFP (Contention Free Period) which is allocated for data to be transmitted to the device by including the slot in the Ack signal.

20. The wireless communication system according to claim 3, wherein upon reception of a request for data transmission from a synchronized device, the coordinator transmits an Ack signal to the device via a data slot in a CAP (Contention Access Period) following the beacon frame, and notifies the device of a slot in a CFP (Contention Free Period) which is allocated for data to be transmitted to the device by including the slot in the Ack signal.
